(19) United States
(12) Patent Application Publication
(10) Pub. No.: US 2019/0335747 A1
(43) Pub. Date: Nov. 7, 2019

(54) LOW TEMPERATURE STABLE HIGH CONCENTRATION FORMULATIONS OF NITRAPYRIN

(71) Applicant: Koch Agronomic Services, LLC, Wichita, KS (US)

(72) Inventors: Drew R. Bobeck, DECATUR, GA (US); Jessica W. Giles, SNELLVILLE, GA (US)

(21) Appl. No.: 16/402,893

(22) Filed: May 3, 2019

Related U.S. Application Data
(60) Provisional application No. 62/666,968, filed on May 4, 2018.

(51) Int. Cl. A01N 25/22; A01N 43/40; C05G 3/08; A01N 25/02; C05C 9/00

(52) U.S. Cl. CPC A01N 25/22; A01N 43/40; C05C 9/00; A01N 25/02; C05G 3/08

(57) ABSTRACT

The present disclosure relates to a high concentration nitrapyrin liquid formulation with improved stability against crystallization and/or freezing under exposure to low temperatures of 0° C. or below, and methods to make and use such a formulation.

The present application claims priority to U.S. Provisional Application No. 62/666,968, filed on May 4, 2018, and entitled “LOW TEMPERATURE STABLE HIGH CONCENTRATION FORMULATIONS OF NITRAPYRIN”, the contents of which are hereby incorporated by reference.

The present disclosure relates to a high concentration nitrapyrin liquid formulation with improved stability against crystallization and/or freezing upon exposure to low temperatures of 0° C. or below. The present disclosure also provides methods to make and use such a formulation.

Nitrapyrin, which is also known as 2-chloro-6-(trichloromethyl)pyridine, is a nitrification inhibitor that helps to retain fertilizer-applied nitrogen in soil in the form of ammonia. It delays the nitrification process by inhibiting the Nitrosomonas spp. bacteria that typically convert ammonia to nitrite, thus preventing the loss of soil nitrogen through leaching, runoff, or gaseous emissions.

Nitrapyrin is formulated and sold under several trade names, including INSTINCT® nitrogen stabilizer and N-SERVE® nitrogen stabilizer (Trademark of Dow AgroSciences LLC). The highest concentration of nitrapyrin in the currently available commercial formulations is no higher than 25% by weight.

Nitrapyrin may and often does precipitate or crystallize out from the solution if the nitrapyrin concentration is too high, especially when the solution is stored at lower temperatures, such as 0° C. or lower, for an extended period of time.

Because concentrated nitrapyrin formulations have certain advantages in transportation, storage, and use on an industrial scale, there is a need to develop highly concentrated formulations, including those that are stable at lower temperatures, such as at 0° C. or lower.

The present disclosure provides a formulation comprising nitrapyrin in a concentration of at least about 30% by weight that is stable to crystallization upon extended exposure to lower temperatures at 0° C. or below, and methods to make and use such a formulation. The present formulations include solvent, such as organic solvents, that provide high solubility and stability of nitrapyrin in the solvent, resistance of the resulting nitrapyrin solution against crystallization or freezing at a low temperature, low viscosity of the concentrated solution of nitrapyrin, low toxicity, low volatility and flammability, and low cost. The formulations of nitrapyrin of the present disclosure may also include a urease inhibitor, such as N-(n-butyl) thiophosphoric triamide (NBPT).

The formulations of the present disclosure may also include a dye. The formulations of the present disclosure have been found to overcome the tendency of dye to expedite crystallization of certain components or freezing of the whole solution at lower temperatures. The present formulations allow for the use of common dyes, including food dyes.

Specifically, the present disclosure provides a formulation comprising nitrapyrin in a concentration of at least about 30% to about 50% by weight that is stable to crystallization upon extended exposure to lower temperatures at 0° C. or below, and methods to make and use such a formulation.

More specifically, the present disclosure provides a formulation comprising:

i) from about 30% to about 50% nitrapyrin, by weight of the total formulation;

ii) a glycol, glycol derivative, and/or alkylene glycol alkyl ether; and/or

iii) N-methyl-2-pyrrolidinone (NMP).

Formulations of the present disclosure may further comprise a urease inhibitor, such as NBPT, a dye, and additional excipients and/or additives.

The formulations of the present disclosure comprise nitrapyrin in an amount ranging from about 30% to about 50% by weight based on the total weight of the formulation. For example, nitrapyrin is present in an amount ranging from about 30% to about 35%, from about 35% to about 40%, from about 40% to about 45%, from about 45% to about 50%, by weight based on the total formulation. In at least one embodiment, nitrapyrin is present in an amount of about 30% by weight. In another embodiment, nitrapyrin is present in an amount of about 35% by weight. In another embodiment, nitrapyrin is present in an amount of about 40% by weight. In another embodiment, nitrapyrin is present in an amount of about 45% by weight. In another embodiment, nitrapyrin is present in an amount of about 50% by weight.

The formulation of the present disclosure may also include a glycol or glycol derivative. Examples of glycols include, but are not limited to, ethylene glycol (commonly referred to as glycol), propylene glycol (PG) (1,2-propanediol), 1,4-butanediol, 1,5-pentanediol, 1,6-hexanediol, 1,10-decanediol, 1,7-heptanediol, 1,9-nonanediol, 1,8-octanediol, 1,3-propanediol, 1,3-butanediol, 1,4-butanediol, 2,3-butanediol, 2,4-pentanediol, 2,5-hexanediol, 4,5-octanediol, and 3,4-hexanediol. Other examples of glycols include, but are not limited to, diethylene glycol and dipropylene glycol.

Examples of glycol derivatives include, but are not limited to, ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, ethylene glycol diethyl ether, ethylene glycol dibutyl ether, ethylene glycol methyl ether acetate, ethylene glycol monoethyl ether acetate, ethylene glycol monobutyl ether acetate, propylene glycol methyl ether acetate, ethylene glycol monostearate, ethylene glycol distearate, ethylene glycol amido stearate, propylene glycol monostearate, propylene glycol dicaprylate, propylene glycol dicaprate diacetate glycol, dilaurate glycol, dipalmite glycol, diforrnate glycol, dibutyrate glycol, dibenzorate glycol, dipalmate glycol, dipropionate glycol, monoacetate glycol, monopalmitate glycol, monoformate glycol, and diethylene glycol monostearate. Examples of glycol derivatives also include, but are not limited to, C₃-C₁₂ triols and/or C₃-C₁₂ triol derivatives, including C₃-C₆ triols, glycerol monostearate, glycerol distearate, glycerol monooleate, glycerol monolaurate, glycerol dilaurate, glycerol dipalmitate, glycerol monopalmitate, glycerol triacetate, glycerol tribenzoate, glycerol tributyrate, glycerol trimyristate, glycerol trioleate, glycerol trilaurate, glycerol tripalmitate, and glycerol tristearate.

In at least one embodiment, the glycol or glycol derivative, such as for example, dipropylene glycol, is present in the formulation of the present disclosure, in an amount of from about 1% to about 50% by weight of the total weight of the formulation. The glycol or glycol derivative may be present in the formulation of the present disclosure in an amount ranging from about 1% to about 50% by weight, such as from about 1% to about 40%, such as from about 1% to about 30%, such as from about 1% to about 20%, such as from about 1% to about 10%, such as from about 1% to about 5%, such as from about 1% to about 2%. In at least one embodiment, the glycol or glycol derivative is present in the formulation of the present disclosure in an amount of about 20% to about 50%, such as from about 20% to about 40%, such as from about 20% to about 30%. The glycol or glycol derivative may be present in the formulation of the present disclosure in an amount of about 25% to about 47%, such as from about 25% to about 45%, from about 25% to about 40%, from about 25% to about 35%, or from about 25% to about 30%. In at least one embodiment, the glycol and/or glycol derivative is present in the formulation of the present disclosure in an amount of about 2.8% by weight. In at least one embodiment, the glycol and/or glycol derivative is present in the formulation of the present disclosure in an amount of about 4.2% by weight. In at least one embodiment, the glycol and/or glycol derivative is present in the formulation of the present disclosure in an amount of about 11.1% by weight. In at least one embodiment, the glycol and/or glycol derivative is present in the formulation of the present disclosure in an amount of about 16.1% by weight. In at least one embodiment, the glycol and/or glycol derivative is present in the formulation of the present disclosure in an amount of about 23% by weight. In at least one embodiment, the glycol and/or glycol derivative is present in the formulation of the present disclosure in an amount of about 47% by weight. In at least one embodiment, the glycol and/or glycol derivative is present in the formulation of the present disclosure in an amount of about 55% by weight.

The formulation of the present disclosure may also include an alkylene glycol alkyl ether. Examples of alkylene glycol alkyl ethers include, but are not limited to, diethylene glycol monoethyl ether, diethylene glycol monopropyl ether, diethylene glycol monopentylyl ether, diethylene glycol monoisopropyl ether, diethylene glycol monoisobutyl ether, diethylene glycol monohexyl ether, triethylene glycol monomethyl ether, triethylene glycol monopropyl ether, triethylene glycol monobuyl ether, triethylene glycol monopentyl ether, triethylene glycol monoisopropyl ether, triethylene glycol monoisobutyl ether, triethylene glycol monohexyl ether, tetraethylene glycol monomethyl ether, tetraethylene glycol monoethyl ether, tetraethylene glycol monopropyl ether, tetraethylene glycol monobutyl ether, tetraethylene glycol monopentyl ether, tetraethylene glycol monoisopropyl ether, tetraethylene glycol monoisobutyl ether, tetraethylene glycol monohexyl ether, dipropylene glycol monoethyl ether, dipropylene glycol monopropyl ether, dipropylene glycol monobutyl ether, dipropylene glycol monopentyl ether, dipropylene glycol monoisopropyl ether, dipropylene glycol monoisobutyl ether, dipropylene glycol monohexyl ether, tripropylene glycol monomethyl ether (MTPGE), tripropylene glycol monoethyl ether, tripropylene glycol monopropyl ether, tripropylene glycol monobutyl ether, tripropylene glycol monopentyl ether, tripropylene glycol monoisopropyl ether, tripropylene glycol monoisobutyl ether, tripropylene glycol monohexyl ether, triethylene glycol monobutyl ether (MTRGE), tetraethylene glycol monobutyl ether (MTEGE), diethylene glycol monobutyl ether (MDGE), and dipropylene glycol dimethyl ether (MDPG).

The formulations of the present disclosure may also include combinations of at least two alkylene glycol alkyl ethers. Examples of commercially available alkylene glycol alkyl ethers include, but are not limited to, FLOMIN F672®, (a blend of ca. MW 250, methyl glycol ethers), FLOMIN F660® (a blend of triethylene glycol monobutyl ether 70-80%, tetraethylene glycol monobutyl ether 15-25%, diethylene glycol monobutyl ether<5%) and FLOMIN F661® (a mixture of triethylene glycol monoethyl ether and triethylene glycol monobutyl ether).

In at least one embodiment, the alkylene glycol alkyl ether, such as for example, FLOMIN F660®, is present in the formulation of the present disclosure, in an amount of from about 0.5% to about 50% by weight of the total weight of the formulation. The alkylene glycol alkyl ether may be present in the formulation of the present disclosure in an amount ranging from about 0.5% to about 50% by weight, such as from about 0.5% to about 40%, such as from about 0.5% to about 30%, such as from about 0.5% to about 20%, such as from about 0.5% to about 10%, such as from about 0.5% to about 5%, such as from about 0.5% to about 1%. In at least one embodiment, the alkylene glycol alkyl ether is present in the formulation of the present disclosure in an amount of about 20% to about 50%, such as from about 20% to about 40%, or such as from about 20% to about 30%. The alkylene glycol alkyl ether may be present in the formulation of the present disclosure in an amount of about 25% to about 47%, such as from about 25% to about 45%, from about 25% to about 40%, from about 25% to about 35%, or from about 25% to about 30%. In at least one embodiment, the alkylene glycol alkyl ether is present in the formulation of the present disclosure in an amount of about 0.8% by weight. In at least one embodiment, the alkylene glycol alkyl ether is present in the formulation of the present disclosure in an amount of about 1.2% by weight. In at least one embodiment, the alkylene glycol alkyl ether is present in the formulation of the present disclosure in an amount of about 3.1% by weight. In at least one embodiment, the alkylene glycol alkyl ether is present in the formulation of the present disclosure in an amount of about 4.5% by weight. In at least one embodiment, the alkylene glycol alkyl ether is present in the formulation of the present disclosure in an amount of about 10% by weight. In at least one embodiment, the alkylene glycol alkyl ether is present in the formulation of the present disclosure in an amount of about 23% by weight. In at least one embodiment, the alkylene glycol alkyl ether is present in the formulation of the present disclosure in an amount of about 25% by weight. In at least one embodiment, the alkylene glycol alkyl ether is present in the formulation of the present disclosure in an amount of about 35% by weight. In at least one embodiment, the alkylene glycol alkyl ether is present in the formulation of the present disclosure in an amount of about 47% by weight.

The formulations of the present disclosure may also include NMP. In at least one embodiment, NMP is present in the formulation of the present disclosure, in an amount of from about 20% to about 70% by weight of the total weight of the formulation. NMP may be present in the formulation of the present disclosure in an amount ranging from about 20% to about 70% by weight, such as from about 20% to about 60%, such as from about 20% to about 50%, such as from about 20% to about 40%, and such as from about 20% to about 30%. NMP may be present in the formulation of the present disclosure in a range of about 23% to about 55%, such as from about 23% to about 45%, such as from about 23% to about 40%, such as from about 23% to about 35%, such as from about 23% to about 30%, or such as from about 23% to about 25%. In at least one embodiment, NMP is present in the formulation of the present disclosure in an amount of about 23% by weight. In at least one embodiment, NMP is present in the formulation of the present disclosure in an amount of about 28.5% by weight. In at least one embodiment, NMP is present in the formulation of the present disclosure in an amount of about 30% by weight. In at least one embodiment, NMP is present in the formulation of the present disclosure in an amount of about 33.3% by weight. In at least one embodiment, NMP is present in the formulation of the present disclosure in an amount of about 35% by weight. In at least one embodiment, NMP is present in the formulation of the present disclosure in an amount of about 37.4% by weight. In at least one embodiment, NMP is present in the formulation of the present disclosure in an amount of about 40% by weight. In at least one embodiment, NMP is present in the formulation of the present disclosure in an amount of about 41.2% by weight. In at least one embodiment, NMP is present in the formulation of the present disclosure in an amount of about 47% by weight. In at least one embodiment, NMP is present in the formulation of the present disclosure in an amount of about 50% by weight. In at least one embodiment, NMP is present in the formulation of the present disclosure in an amount of about 55% by weight. In at least one embodiment, NMP is present in the formulation of the present disclosure in an amount of about 58.2% by weight. In at least one embodiment, NMP is present in the formulation of the present disclosure in an amount of about 70% by weight. In the formulations of the present disclosure, NMP may be combined with at least one of a glycol, glycol derivative and/or alkylene glycol alkyl ether. Alternatively, NMP may be present in the concentrated nitrapyrin formulation that does not contain any of a glycol, glycol derivative and/or alkylene glycol alkyl ether.

The formulation of the present disclosure may also include a dye. Examples of dyes include, but are not limited to, FD&C Blue No. 1, FD&C Blue No. 1, FD&C Green No. 3, FD&C Yellow No. 5, FD&C Red No. 3, FD&C Red No. 40, FD&C Yellow No. 6, and AGROTAIN® ULTRA green dye. In at least one embodiment, the dye, such as for example, AGROTAIN® ULTRA green dye, is present in the formulation of the present disclosure, in an amount of from about 0.01% to about 5% by weight of the total weight of the formulation. The dye may be present in the formulation of the present disclosure in an amount ranging from about 0.01% to about 5% by weight, such as from about 0.02% to about 5%, such as from about 0.05% to about 5%, such as from about 0.1% to about 5%, such as from about 0.5% to about 5%, such as from about 1% to about 5%, such as from about 2% to about 5%, such as from about 3% to about 5%, such as from about 4% to about 5%, such as from about 0.01% to about 2%, such as from about 0.05% to about 2%, such as from about 0.1% to about 2%, such as from about 0.5% to about 2%, such as from about 1% to about 2%, such as from about 0.01% to about 1%, such as from 0.05% to 1%, such as from 0.1% to 1%, such as from 0.5% to 1%. In at least one embodiment, the dye is present in the formulation of the present disclosure in an amount of about 0.10% by weight. In at least one embodiment, the dye is present in the formulation of the present disclosure in an amount of about 0.16% by weight.

The formulation of the present disclosure may also include a urease inhibitor. As used herein, “urease inhibitor” refers to any compound that reduces, inhibits, or otherwise slows down the conversion of urea to ammonium (NH₄⁺) in soil when present as compared to the conversion of urea to ammonium (NH₄⁺) in soil when the urease inhibitor is not present. Examples of urease inhibitors include, but are not limited to, N-(n-butyl)thiophosphoric triamide (NBPT), N-(n-butyl)thiophosphorictriamide, N-(n-butyl)phosphoric triamide, thiophosphoryl triamide, phenylphosphorodiamidate, cyclohexyl phosphoric triamide, cyclohexyl thiophosphoric triamide, phosphoric triamide, hydroquinone, p-benzoquinone, hexamidocyclotriphosphazene, thiopyridines, thiopyrimidines, thiopyridine-N-oxides, N,N-dihalo-2-imidazolidinone, N-halo-2-oxazolidinone and derivatives thereof. In at least one embodiment, the urease inhibitor such as for example, NBPT, is present in the formulation of the present disclosure, in an amount of from about 1% to about 50% by weight of the total weight of the formulation. The urease inhibitor may be present in the formulation of the present disclosure in an amount ranging from about 1% to about 50% by weight, such as from about 1% to about 40%, such as from about 1% to about 30%, such as from about 1% to about 20%, such as from about 1% to about 10%, such as from about 1% to about 5%. The urease inhibitor may be present in the formulation of the present disclosure in a range of about 5% to about 25%, about 5% to about 20%, or about 5% to about 10%. The urease inhibitor may be present in the formulation of the present disclosure in a range of about 10% to about 50%, such as about 10% to about 40%, such as about 10% to about 30%, and such as about 10% to about 20%. In at least one embodiment, the urease inhibitor is present in the formulation of the present disclosure in an amount of about 4.8% by weight. In at least one embodiment, the urease inhibitor is present in the formulation of the present disclosure in an amount of about 7.14% by weight.

The formulation of the present disclosure may also include one or more excipients or additives. The excipient may be water, a surfactant, a solvent, or any combination thereof. In at least one embodiment, the surfactant is selected from octylphenol polyether alcohol, sulfosuccinate, naphthalene sulfonate, sulfated ester, phosphate ester, sulfated alcohol, alkyl benzene sulfonate, polycarboxylate, naphthalene sulfonate condensate, phenol sulfonic acid condensate, lignosulfonate, methyl oleyl taurate, polyvinyl alcohol, polysorbates, or any combination thereof. In at least one embodiment, the solvent is selected from benzyl alcohol, dimethyl sulfoxide (DMSO), morpholine, and ethoxylated amines.

The present disclosure also provides a method of making a concentrated nitrapyrin formulation comprising combining nitrapyrin; a glycol, glycol derivative and/or alkylene glycol alkyl ether; and/or NMP to make a homogeneous solution. In at least one embodiment, the method further comprises adding a dye. In another embodiment, the method further comprises adding a urease inhibitor, such as for example, NBPT. In any of the foregoing embodiments, a surfactant may be added to the concentrated nitrapyrin formulation. The surfactant can be selected from octylphenol polyether alcohol, sulfosuccinate, naphthalene sulfonate, sulfated ester, phosphate ester, sulfated alcohol, alkyl benzene sulfonate, polycarboxylate, naphthalene sulfonate condensate, phenol sulfonic acid condensate, lignosulfonate, methyl oleyl taurate, polyvinyl alcohol, polysorbates, or any combination thereof.

In one embodiment, the present disclosure provides a method to make an incorporated urea-containing fertilizer comprising adding a concentrated nitrapyrin formulation into a molten urea-containing fertilizer.

In a further embodiment, a concentrated nitrapyrin formulation according to the present disclosure can be applied to solid urea-containing fertilizers, such as coating granular urea, added into molten urea-containing fertilizers to make nitrapyrin incorporated urea-containing fertilizers (as described in WO2015/027244 and U.S. Prov. Appl. No. 62/120,101), or added into liquid urea-containing fertilizers.

For example, a nitrapyrin formulation according to the present disclosure can be incorporated into a homogenous urea-based fertilizer formulation by blending said concentrated nitrapyrin formulation directly with molten urea at a temperature of about 120° C. to about 150° C. before the granulation or prilling of the urea. Sufficient mixing is employed during this blending step to assure that the concentrated nitrapyrin formulation is homogeneously distributed throughout the molten urea before the melt cools and solidifies in the subsequent granulation step.

In another embodiment, the present disclosure provides a method comprising contacting a nitrapyrin formulation of the present disclosure with a urea-based fertilizer.

The present disclosure also includes methods for fertilizing soil. In at least one embodiment, the soil may be treated by contacting it directly with a formulation of the present disclosure. In at least one embodiment, contacting the soil with a formulation of the present disclosure may comprise administering a formulation of the present disclosure as a spray. In another embodiment, contacting the soil with a formulation of the present disclosure may comprise administering a formulation of the present disclosure as granules. In at least one embodiment, contacting the soil comprises administering a formulation of the present disclosure as a powder. In at least one embodiment, contacting the soil comprises adding a formulation of the present disclosure to the irrigation water for the soil.

The formulations of the present disclosure are stable and do not exhibit crystallization at low temperatures, such as at 0° C. or below. The formulations of the present disclosure are stable at such low temperatures for extended periods of time, including for example, during storage. In other words, the formulations of the present disclosure remain in liquid form at low temperatures and/or for extended periods of time, such as for example, at least 2 weeks, at least one month, at least 6 months, at least one year, or at least 1.5 years.

The term “temperature of 0° C. or below” means a temperature range from about −15° C. to 0° C.

The formulations of the present disclosure are stable meaning they exhibit substantially no freezing of the formulation and/or crystallization, such that less than about 5% of the total solution is frozen and/or less than about 5% of total solids crystallize out from solution at a temperature of 0° C. or below.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other acceptable order.

### EXAMPLES

### Example 1: Concentrated Nitrapyrin Solution

### General Preparation Method:

A 66.08 wt. percent stock solution of nitrapyrin in NMP was formulated. This solution was made by taking crystalline nitrapyrin and grinding it to a homogeneous coarse powder with a mortar and pestle. Then the appropriate amount of ground nitrapyrin corresponding to 66.08 wt. percent of the final solution was added to 33.92 wt. percent NMP in a glass vessel. A stir bar was then added and the solution stirred at room temperature (22° C.) on a stir plate until the nitrapyrin was fully dissolved into the solution. This typically took 3-4 hours depending on stir plate rpm. Aliquots were then taken of the previously mentioned stock solution and formulated into the appropriate formulations via further dilution with the appropriate solvents (additional NMP, glycol/glycol derivatives, and/or alkylene glycol alkyl ethers). The final formulations were placed into a glass vessel. A stir bar was then inserted and the solutions were stirred at room temperature for 10 minutes to ensure a homogenous mixture.

### Example 2: Formulation of Nitrapyrin (30.00%), FLOMIN F660 (46.67%) and NMP (23.33%) Solution

According to example 1, 66.08 wt. percent nitrapyrin in NMP stock solution was formulated. In a glass vessel, a stir bar and 45.40 g of 66.08 wt. percent nitrapyrin in NMP stock solution were added and placed on stir plate. To which, was added 7.93 g additional NMP followed by 46.67 g FLOMIN F660. The stir plate was turned on and the formulation stirred at room temperature (22° C.) for 10 minutes to ensure homogeneity.

### Example 3: Stability Experiments

Formulations in the following table were prepared according to Examples 1 and 2 using appropriate amounts of nitrapyrin stock solution and the remaining components.

| | | 0° C. | −15° C. | |
|---|---|---|---|---|
| Entry | Formulation | stability | stability | −10° C. stability |
| 1 | 30% Nitrapyrin, 15.4% NMP, | Crystallized out immediately at Room temp. | | |
| | 54.6% PG | | | |
| 2 | 30% Nitrapyrin, 15.4% NMP, | Crystallized out immediately at Room temp. | | |
| | 54.6% ethylene glycol | | | |
| 3 | 30% Nitrapyrin, 15.4% NMP, | Liquid at 30 | 50 days | ≤3 days |
| | 54.6% FLOMIN F660 | days | | |
| 4 | 30% Nitrapyrin, 15.4% NMP, | <1 day | <1 day | |
| | 54.6% diethylene glycol | | | |
| 5 | 30% Nitrapyrin, 15.4% NMP, | <1 day | <1 day | |
| | 54.6% dipropylene glycol | | | |
| 6 | 30% Nitrapyrin, 70% NMP | Liquid >30 | Liquid >400 | Liquid >400 |
| | | days | days | days |
| 7 | 30% Nitrapyrin, 23.33% NMP, | <1 day | <1 day | |
| | 46.67% PG | | | |
| 8 | 30% Nitrapyrin, 35% NMP, 35% | t = 17 days | ≤3 days | |
| | PG | | | |
| 9 | 30% Nitrapyrin, 46.67% NMP, | Liquid >21 | 5 days | ≤3 days |
| | 23.33% PG | days | | |
| 10 | 30% Nitrapyrin, 23.33% NMP, | Liquid >30 | Liquid >400 | Liquid >400 |
| | 46.67% FLOMIN F660 | days | days | days |
| 11 | 30% Nitrapyrin, 35% NMP, 35% | Liquid >30 | Liquid >400 | Liquid >400 |
| | FLOMIN F660 | days | days | days |
| 12 | 30% Nitrapyrin, 46.67% NMP, | Liquid >30 | Liquid >400 | Liquid >400 |
| | 23.33% FLOMIN F660 | days | days | days |
| 13 | 30% Nitrapyrin, 23.33% NMP, | ≤3 days | ≤3 days | |
| | 46.67% diethylene glycol | | | |
| 14 | 30% Nitrapyrin, 35% NMP, 35% | Liquid >21 | 27 days | ≤3 days |
| | diethylene glycol | days | | |
| 15 | 30% Nitrapyrin, 46.67% NMP, | Liquid >21 | Liquid >400 | Liquid >391 |
| | 23.33% diethylene glycol | days | days | days |
| 16 | 30% Nitrapyrin, 23.33% NMP, | Crystallized out immediately at Room temp. | | |
| | 46.67% ethylene glycol | | | |
| 17 | 30% Nitrapyrin, 35% NMP, 35% | 1 day | 1 day | |
| | ethylene glycol | | | |
| 18 | 30% Nitrapyrin, 46.67% NMP, | Liquid >21 | 1 day | ≤3 days |
| | 23.33% ethylene glycol | days | | |
| 19 | 30% Nitrapyrin, 23.33% NMP, | Liquid >21 | 1 day | ≤3 days |
| | 46.67% Dipropylene glycol | days | | |
| 20 | 30% Nitrapyrin, 35% NMP, | 2 days | 2 days | |
| | 35% Dipropylene glycol | | | |
| 21 | 30% Nitrapyrin, 46.67% NMP, | Liquid >17 | Liquid >400 | Liquid >387 |
| | 23.33% Dipropylene glycol | days | days | days |
| 22 | 60% Nitrapyrin, 30.8% NMP, | <1 day | | |
| | 9.2% FLOMIN F660 | | | |
| 23 | 50% Nitrapyrin, 20% NMP, 30% | <1 day | | |
| | FLOMIN F660 | | | |
| 24 | 50% Nitrapyrin, 50% NMP | Liquid >17 | 2 days | 15 days |
| | | days | | |
| 25 | 45% Nitrapyrin, 45% NMP, | Liquid >17 | 2 days | 15 days |
| | 10% FLOMIN F660 | days | | |
| 26 | 45% Nitrapyrin, 30% NMP, | Liquid >17 | Liquid >385 | Liquid >351 |
| | 25% FLOMIN F660 | days | days | days |
| 27 | 40% Nitrapyrin, 40% NMP, | Liquid >17 | Liquid >385 | Liquid >351 |
| | 20% FLOMIN F660 | days | days | days |
| 28 | 35% Nitrapyrin, 55% NMP, | Liquid >17 | Liquid >385 | Liquid >351 |
| | 10% FLOMIN F660 | days | days | days |
| 29 | 35% Nitrapyrin, 30% NMP, | Liquid >17 | Liquid >385 | Liquid >351 |
| | 35% FLOMIN F660 | days | days | days |
| 30 | 30% Nitrapyrin, 46.67% NMP, | | Liquid >357 | Liquid >328 |
| | 23.33% FLOMIN F660 | | days | days |
| 31 | 45% Nitrapyrin, 30% NMP, | | 1 day | 2 days |
| | 25% FLOMIN F660 | | | |
| 32 | 45% Nitrapyrin, 30% NMP, | | 1 day | 1 day |
| | 25% FLOMIN F660 | | | |
| 33 | 50% Nitrapyrin, 50% NMP | | 1 day | 1 day |
| 34 | 45% Nitrapyrin, 45% NMP, | | 2 days | 7 days |
| | 10% FLOMIN F660 | | | |
| 35 | 30% Nitrapyrin, 20% NMP, | | 16 days | 16 days |
| | 50% FLOMIN F660 | | | |
| 36 | 35% Nitrapyrin, 30% NMP, | | Liquid >357 | Liquid >328 |
| | 35% FLOMIN F660 | | days | days |
| 37 | 30% Nitrapyrin, 70% NMP | | Liquid >357 | Liquid >328 |
| | | | days | days |
| 38 | 35% Nitrapyrin, 55% NMP, | | Liquid >357 | Liquid >328 |
| | 10% FLOMIN F660 | | days | days |
| 39 | 40% Nitrapyrin, 40% NMP, | | Liquid >357 | Liquid >328 |
| | 20% FLOMIN F660 | | days | days |

| | | |
|---|---|---|
| 40 | 50% Nitrapyrin, 20% NMP, | <1 day |
| | 30% FLOMIN F660 | |

Formulations according to the table above were tested for their stability at 0° C., −10° C., and −15° C. to determine if they would freeze or if any solid would precipitate from the solution at 0° C. or below after being stored at 0° C. or below for at least 14 days.

A formulation (Examples 1-40) in a sealed jar was placed into a freezer that is set to the desired temperature (0° C., −10° C., and −15° C.). The time when the sample is first placed into the freezing temperature is set to time zero. Samples are monitored daily for solidification by slowly tilting each container to observe for fluidity. Freezing time is based on the time at which a particular formulation appeared to be solidified. Formulations that appear to be solidified are removed to ambient temperature and allowed to thaw. Some samples that are frozen may re-solubilize when the temperature is brought to ambient conditions. Other samples that are frozen may remain as solid after elevating the temperature to ambient. The samples are kept at 0° C., −10° C., and −15° C. for at least 14 days.

### Results

Formulations 6, 10-12, 15, 21, 26-30, and 36-39 remained as a homogeneous solution after at least 357 days at −15° C. The stability test demonstrates that the formulations of entries 6, 10-12, 15, 21, 26-30, and 36-39 can maintain a homogeneous solution for at least 357 days at −15° C. The stability test also shows that the formulations of entries 3 and 14, which each comprise 30% nitrapyrin by weight can maintain a homogeneous solution for at least 27 days at −15° C. Also, the stability test indicates that the formulations of entries 24 and 25, which each comprise 50% and 45% nitrapyrin by weight, respectively, can maintain a homogeneous solution for at least 15 days at −15° C.

### Example 4: Concentrated Nitrapyrin and NBPT Formulation

| | | | | Glycol | | |
|---|---|---|---|---|---|---|
| | | | | Ethers | | AGROTAIN |
| | | NBPT | Propylene | (FLOMIN | NMP | Ultra Green |
| | Nitrapyrin | (% | Glycol | F660) | (% | Blend Dye |
| Entry | (% w/w) | w/w) | (% w/w) | (% w/w) | w/w) | (% w/w) |
| 41 | 50.00 | 7.14 | 11.13 | 3.10 | 28.47 | 0.16 |
| 42 | 50.00 | 7.14 | 4.17 | 1.17 | 37.36 | 0.16 |
| 43 | 33.31 | 4.79 | 16.11 | 4.48 | 41.21 | 0.10 |
| 44 | 33.31 | 4.79 | 2.82 | 0.78 | 58.20 | 0.10 |

Formulations 41-44, according to the table above, each include nitrapyrin and, a urease inhibitor, NBPT, in a mixture of solvents, PG, glycol ethers (such as FLOMIN F660) and NMP. These formulations also contained a dye, such as AGROTAIN Ultra Green Blend Dye. These liquid formulations contain a high concentration nitrapyrin, ranging from about 33.3% by wt. to about 50.0% by wt.

Embodiments of the present disclosure further relate to any one or more of the following paragraphs:

### Embodiment 1

A formulation, comprising: i) nitrapyrin in an amount ranging from about 30% to about 50% by weight; ii) a glycol, a glycol derivative, and/or an alkylene glycol alkyl ether in an amount ranging from about 10% to about 50% by weight; and/or iii) N-methyl-2-pyrrolidinone (NMP) in an amount ranging from about 20% to about 70% by weight; wherein each component is present in amount by weight of the total formulation.

### Embodiment 2

The formulation of Embodiment 1, further comprising a urease inhibitor.

### Embodiment 3

The formulation of any one of Embodiments 1 or 2, further comprising an excipient.

### Embodiment 4

The formulation of any one of Embodiments 1 to 3, further comprising a dye.

### Embodiment 5

A formulation, comprising: i) nitrapyrin in an amount ranging from about 30% to about 50% by weight; ii) a urease inhibitor in an amount ranging from about 1% to about 10% by weight; iii) a glycol, a glycol derivative, and/or an alkylene glycol alkyl ether in an amount ranging from about 3% to about 50% by weight; and/or iv) N-methyl-2-pyrrolidinone (NMP) in an amount ranging from about 20% to about 70% by weight; wherein each component is present in amount by weight of the total formulation.

### Embodiment 6

The formulation of Embodiment 5, further comprising an excipient.

### Embodiment 7

The formulation of any one of Embodiments 5 or 6, further comprising a dye.

### Embodiment 8

The formulation of any one of Embodiments 1 or 5, wherein said glycol or glycol derivative or alkylene glycol alkyl ether is diethylene glycol.

### Embodiment 9

The formulation of any one of Embodiments 1 or 5, wherein said glycol or glycol derivative or alkylene glycol alkyl ether is dipropylene glycol.

### Embodiment 10

The formulation of any one of Embodiments 1 or 5, wherein said glycol or glycol derivative or alkylene glycol alkyl ether is an alkylene glycol alkyl ether selected from diethylene glycol monoethyl ether, diethylene glycol monopropyl ether, diethylene glycol monopentyl ether, diethylene glycol monoisopropyl ether, diethylene glycol monoisobutyl ether, diethylene glycol monohexyl ether, triethylene glycol monomethyl ether, triethylene glycol monopropyl ether, triethylene glycol monobutyl ether, triethylene glycol monopentyl ether, triethylene glycol monoisopropyl ether, triethylene glycol monoisobutyl ether, triethylene glycol monohexyl ether, tetraethylene glycol monomethyl ether, tetraethylene glycol monoethyl ether, tetraethylene glycol monopropyl ether, tetraethylene glycol monobutyl ether, tetraethylene glycol monopentyl ether, tetraethylene glycol monoisopropyl ether, tetraethylene glycol monoisobutyl ether, tetraethylene glycol monohexyl ether, dipropylene glycol monoethyl ether, dipropylene glycol monopropyl ether, dipropylene glycol monobutyl ether, dipropylene glycol monopentyl ether, dipropylene glycol monoisopropyl ether, dipropylene glycol monoisobutyl ether, dipropylene glycol monohexyl ether, tripropylene glycol monoethyl ether, tripropylene glycol monopropyl ether, tripropylene glycol monobutyl ether, tripropylene glycol monopentyl ether, tripropylene glycol monoisopropyl ether, tripropylene glycol monoisobutyl ether, tripropylene glycol monohexyl ether, and combinations thereof.

### Embodiment 11

The formulation of any one of Embodiments 1 or 5, wherein said alkylene glycol alkyl ether is a mixture of triethylene glycol monobutyl ether, tetraethylene glycol monobutyl ether, and diethylene glycol monobutyl ether.

### Embodiment 12

The formulation of Embodiment 11, wherein said mixture of triethylene glycol monobutyl ether, tetraethylene glycol monobutyl ether, and diethylene glycol monobutyl ether alkylene glycol alkyl ether contains 70-80% triethylene glycol monobutyl ether, 15-25% tetraethylene glycol monobutyl ether, and less than 5% diethylene glycol monobutyl ether.

### Embodiment 13

The formulation of any one of Embodiments 2 or 5, wherein the urease inhibitor is N-(n-butyl) thiophosphoric triamide (NBPT).

### Embodiment 14

The formulation of any one of Embodiments 1 or 5, wherein the formulation is stable at 0° C.

### Embodiment 15

The formulation of Embodiment 14, wherein the formulation is stable for 2 weeks.

### Embodiment 16

The formulation of Embodiment 14, wherein the formulation is stable for about 1 month.

### Embodiment 17

The formulation of Embodiment 14, wherein the formulation is stable for about 6 months.

### Embodiment 18

The formulation of Embodiment 14, wherein the formulation is stable for about 1 year.

### Embodiment 19

The formulation of Embodiment 14, wherein the formulation is stable for about 1.5 years.

### Embodiment 20

The formulation of any one of Embodiment 14 to 19, wherein less than about 5% of the total solution is frozen.

### Embodiment 21

The formulation of any one of Embodiment 14 to 19, wherein less than about 5% of total solids crystallize out from solution.

### Embodiment 22

The formulation of any one of Embodiments 1 or 5, wherein the formulation is stable at −10° C.

### Embodiment 23

The formulation of Embodiment 22, wherein the formulation is stable for 2 weeks.

### Embodiment 24

The formulation of Embodiment 22, wherein the formulation is stable for about 1 month.

### Embodiment 25

The formulation of Embodiment 22, wherein the formulation is stable for about 6 months.

### Embodiment 26

The formulation of Embodiment 22, wherein the formulation is stable for about 1 year.

### Embodiment 27

The formulation of Embodiment 22, wherein the formulation is stable for about 1.5 years.

### Embodiment 28

The formulation of any one of Embodiments 22 to 27, wherein less than about 5% of the total solution is frozen.

### Embodiment 29

The formulation of any one of Embodiments 22 to 27, wherein less than about 5% of total solids crystallize out from solution.

### Embodiment 30

The formulation of any one of Embodiments 1 or 5, wherein the formulation is stable at −15° C.

### Embodiment 31

The formulation of Embodiment 30, wherein the formulation is stable for 2 weeks.

### Embodiment 32

The formulation of Embodiment 30, wherein the formulation is stable for about 1 month.

### Embodiment 33

The formulation of Embodiment 30, wherein the formulation is stable for about 6 months.

### Embodiment 34

The formulation of Embodiment 30, wherein the formulation is stable for about 1 year.

### Embodiment 35

The formulation of Embodiment 30, wherein the formulation is stable for about 1.5 years.

### Embodiment 36

The formulation of any one of Embodiments 30 to 35, wherein less than about 5% of the total solution is frozen.

### Embodiment 37

The formulation of any one of Embodiment 30 to 35, wherein less than about 5% of total solids crystallize out from solution.

### Embodiment 38

The formulation of Embodiment 1, wherein nitrapyrin is present in an amount of about 30% by weight and NMP is present in an amount of about 70% by weight.

### Embodiment 39

The formulation of Embodiment 1, wherein nitrapyrin is present in an amount of about 30% by weight; a glycol, a glycol derivative and/or alkylene glycol alkyl ether is present in an amount of about 47% by weight; and NMP is present in an amount of about 23% by weight.

### Embodiment 40

The formulation of Embodiment 36, wherein nitrapyrin is present in an amount of 30.00% by weight; a glycol, a glycol derivative and alkylene glycol alkyl ether is present in an amount of 46.67% by weight; and/or NMP is present in an amount of 23.33% by weight.

### Embodiment 41

The formulation of Embodiment 1, wherein nitrapyrin is present in an amount of about 30% by weight; a glycol, a glycol derivative and/or alkylene glycol alkyl ether is present in an amount of about 35% by weight; and NMP is present in an amount of about 35% by weight.

### Embodiment 42

The formulation of Embodiment 1, wherein nitrapyrin is present in an amount of about 30% by weight; a glycol, a glycol derivative and/or alkylene glycol alkyl ether is present in an amount of about 23% by weight; and NMP is present in an amount of about 47% by weight.

### Embodiment 43

The formulation of Embodiment 39, wherein nitrapyrin is present in an amount of 30.00% by weight; a glycol, a glycol derivative and/or alkylene glycol alkyl ether is present in an amount of 23.33% by weight; and NMP is present in an amount of 46.67% by weight.

### Embodiment 44

The formulation of Embodiment 1, wherein nitrapyrin is present in an amount of about 35% by weight; a glycol, a glycol derivative and/or alkylene glycol alkyl ether is present in an amount of about 10% by weight; and NMP is present in an amount of about 55% by weight.

### Embodiment 45

The formulation of Embodiment 1, wherein nitrapyrin is present in an amount of about 35% by weight; a glycol, a glycol derivative and/or alkylene glycol alkyl ether is present in an amount of about 35% by weight; and NMP is present in an amount of about 30% by weight.

### Embodiment 46

The formulation of Embodiment 1, wherein nitrapyrin is present in an amount of about 40% by weight; a glycol, a glycol derivative and/or alkylene glycol alkyl ether is present in an amount of about 20% by weight; and NMP is present in an amount of about 40% by weight.

### Embodiment 47

The formulation of Embodiment 1, wherein nitrapyrin is present in an amount of about 45% by weight; a glycol, a glycol derivative and/or alkylene glycol alkyl ether is present in an amount of about 25% by weight; and NMP is present in an amount of about 30% by weight.

### Embodiment 48

The formulation of Embodiment 1, wherein nitrapyrin is present in an amount of about 50% by weight, and NMP is present in an amount of about 50% by weight.

### Embodiment 49

The formulation of Embodiment 1, wherein nitrapyrin is present in an amount of about 30% by weight and NMP is present in an amount of about 70% by weight.

### Embodiment 50

The formulation of Embodiment 7, wherein nitrapyrin is present in an amount of about 50% by weight; a glycol, a glycol derivative and/or alkylene glycol alkyl ether is present in an amount of about 14.2% by weight; NMP is present in an amount of about 28.5% by weight; a urease inhibitor is present in an amount of about 7.1% by weight; and a dye is present in an amount of about 0.2% by weight.

### Embodiment 51

The formulation of Embodiment 7, wherein nitrapyrin is present in an amount of about 50% by weight; a glycol, a glycol derivative and/or alkylene glycol alkyl ether is present in an amount of about 5.3% by weight; NMP is present in an amount of about 37.4% by weight; a urease inhibitor is present in an amount of about 7.1% by weight; and a dye is present in an amount of about 0.2% by weight.

### Embodiment 52

The formulation of Embodiment 7, wherein nitrapyrin is present in an amount of about 33.3% by weight; a glycol, a glycol derivative and/or alkylene glycol alkyl ether is present in an amount of about 20.6% by weight; NMP is present in an amount of about 41.2% by weight; a urease inhibitor is present in an amount of about 4.8% by weight; and a dye is present in an amount of about 0.1% by weight.

### Embodiment 53

The formulation of Embodiment 7, wherein nitrapyrin is present in an amount of about 33.3% by weight; a glycol, a glycol derivative and/or alkylene glycol alkyl ether is present in an amount of about 3.6% by weight; NMP is present in an amount of about 58.2% by weight; a urease inhibitor is present in an amount of about 4.8% by weight; and a dye is present in an amount of about 0.1% by weight.

### Embodiment 54

The formulation of any one of the proceeding Embodiments, wherein the formulation comprises a surfactant selected from octylphenol polyether alcohol, sulfosuccinate, naphthalene sulfonate, sulfated ester, phosphate ester, sulfated alcohol, alkyl benzene sulfonate, polycarboxylate, naphthalene sulfonate condensate, phenol sulfonic acid condensate, lignosulfonate, methyl oleyl taurate, polyvinyl alcohol, polysorbates, or any combination thereof.

### Embodiment 55

A method of making a nitrapyrin formulation according to any one of the preceding Embodiment, the method comprising: mixing nitrapyin; at least one of a glycol, a glycol derivative or alkylene glycol alkyl ether; and NMP.

### Embodiment 56

A method of making an incorporated urea-containing fertilizer, the method comprising mixing the formulation according to any one of Embodiments 1 to 54 into a molten urea-containing fertilizer.

### Embodiment 57

A method of fertilizing soil, the method comprising: contacting soil with a formulation according to any one of Embodiment 1 to 45.

### Embodiment 58

The method of Embodiment 57, wherein the formulation is sprayed onto the soil.

### Embodiment 59

The method of Embodiment 57, wherein the formulation of Embodiment 1 is added to the irrigation water of the soil.

What is claimed is:

1. A formulation, comprising:
i) nitrapyrin in an amount ranging from about 30% to about 50% by weight;
ii) a glycol, a glycol derivative, and/or an alkylene glycol alkyl ether in an amount ranging from about 10% to about 50% by weight; and/or
iii) N-methyl-2-pyrrolidinone (NMP) in an amount ranging from about 20% to about 70% by weight;
wherein each component is present in amount by weight of the total formulation.

2. The formulation of claim 1, further comprising a urease inhibitor.

3. The formulation of claim 1, further comprising an excipient.

4. The formulation of claim 1, further comprising a dye.

5. The formulation of claim 1, wherein said glycol or glycol derivative or alkylene glycol alkyl ether is diethylene glycol or dipropylene glycol.

6. The formulation of claim 1, wherein said glycol or glycol derivative or alkylene glycol alkyl ether is an alkylene glycol alkyl ether selected from diethylene glycol monoethyl ether, diethylene glycol monopropyl ether, diethylene glycol monopentyl ether, diethylene glycol monoisopropyl ether, diethylene glycol monoisobutyl ether, diethylene glycol monohexyl ether, triethylene glycol monomethyl ether, triethylene glycol monopropyl ether, triethylene glycol monobutyl ether, triethylene glycol monopentyl ether, triethylene glycol monoisopropyl ether, triethylene glycol monoisobutyl ether, triethylene glycol monohexyl ether, tetraethylene glycol monomethyl ether, tetraethylene glycol monoethyl ether, tetraethylene glycol monopropyl ether, tetraethylene glycol monobutyl ether, tetraethylene glycol monopentyl ether, tetraethylene glycol monoisopropyl ether, tetraethylene glycol monoisobutyl ether, tetraethylene glycol monohexyl ether, dipropylene glycol monoethyl ether, dipropylene glycol monopropyl ether, dipropylene glycol monobutyl ether, dipropylene glycol monopentyl ether, dipropylene glycol monoisopropyl ether, dipropylene glycol monoisobutyl ether, dipropylene glycol monohexyl ether, tripropylene glycol monoethyl ether, tripropylene glycol monopropyl ether, tripropylene glycol monobutyl ether, tripropylene glycol monopentyl ether, tripropylene glycol monoisopropyl ether, tripropylene glycol monoisobutyl ether, tripropylene glycol monohexyl ether, and combinations thereof.

7. The formulation of claim 1, wherein said alkylene glycol alkyl ether is a mixture of triethylene glycol monobutyl ether, tetraethylene glycol monobutyl ether, and diethylene glycol monobutyl ether.

8. The formulation of claim 7, wherein said mixture of triethylene glycol monobutyl ether, tetraethylene glycol monobutyl ether, and diethylene glycol monobutyl ether alkylene glycol alkyl ether contains 70-80% triethylene glycol monobutyl ether, 15-25% tetraethylene glycol monobutyl ether, and less than 5% diethylene glycol monobutyl ether.

9. The formulation of claim 2, wherein the urease inhibitor is N-(n-butyl) thiophosphoric triamide (NBPT).

10. The formulation of claim 1, wherein the formulation is stable at 0° C.

11. The formulation of claim 10, wherein the formulation is stable for at least 2 weeks.

12. The formulation of claim 10, wherein less than about 5% of the total solution is frozen and/or wherein less than about 5% of total solids crystallize out from solution.

13. The formulation of claim 1, wherein nitrapyrin is present in an amount of about 30% by weight and NMP is present in an amount of about 70% by weight.

14. The formulation of claim 1, wherein nitrapyrin is present in an amount of about 30% by weight; a glycol, a glycol derivative and/or alkylene glycol alkyl ether is present in an amount of about 47% by weight; and NMP is present in an amount of about 23% by weight.

15. The formulation of claim 1, wherein nitrapyrin is present in an amount of about 50% by weight; a glycol, a glycol derivative and/or alkylene glycol alkyl ether is present in an amount of about 14.2% by weight; NMP is present in an amount of about 28.5% by weight; a urease inhibitor is present in an amount of about 7.1% by weight; and a dye is present in an amount of about 0.2% by weight.

16. The formulation of claim 1, further comprising a surfactant selected from octylphenol polyether alcohol, sulfosuccinate, naphthalene sulfonate, sulfated ester, phosphate ester, sulfated alcohol, alkyl benzene sulfonate, polycarboxylate, naphthalene sulfonate condensate, phenol sulfonic acid condensate, lignosulfonate, methyl oleyl taurate, polyvinyl alcohol, polysorbates, or any combination thereof.

17. A method of making a nitrapyrin formulation, the method comprising: mixing nitrapyin; at least one of the following: a glycol, a glycol derivative or alkylene glycol alkyl ether; and NMP to form a composition according to claim 1.

18. A method of making an incorporated urea-containing fertilizer, the method comprising: mixing the nitrapyrin formulation according to claim 1 into a molten urea-containing fertilizer.

19. A method of fertilizing soil, the method comprising: contacting soil with a formulation according to claim 1.

20. The method of claim 19, wherein the formulation is sprayed onto the soil.
